(19) United States
(12) Patent Application Publication
(10) Pub. No.: US 2026/0246656 A1
(43) Pub. Date: Aug. 20, 2026

(54) CONTROL APPARATUS, FRONTHAUL MULTIPLEXER, CONNECTION SWITCHING METHOD AND MULTIPLEXING METHOD

(71) Applicant: NTT, Inc., Tokyo (JP)

(72) Inventors: Hirotaka UJIKAWA, Musashino-shi (JP); Tatsuya SHIMADA, Musashino-shi (JP); Yoshihito SAKAI, Musashino-shi (JP); Kenji MIYAMOTO, Musashino-shi (JP); Karin UMEDA, Musashino-shi (JP)

(73) Assignee: NTT, Inc., Tokyo (JP)

(21) Appl. No.: 19/489,549

(22) PCT Filed: Jun. 7, 2023
(86) PCT No.: PCT/JP2023/021182

§ 371 Date: Dec. 2, 2025

(51) Int. Cl. H04L 12/12

(52) U.S. Cl. CPC H04L 12/12

(57) ABSTRACT

A control device that includes a sleep detection unit that detects a migration of a communication station, which is connected to a first path via an optical distribution unit that outputs signals outputted from one or more terminal accommodation stations to another path and not via a fronthaul multiplexer that multiplexes and outputs signals outputted from the one or more terminal accommodation stations, to a sleep state among a plurality of communication stations that accommodates the one or more terminal accommodation stations that communicate with a terminal, and a switching signal transmission unit that transmits a switching signal to the optical distribution unit that instructs to switch the terminal accommodation station accommodated in the communication station that has migrated to the sleep state to be accommodated in the communication station connected to a second path via the optical distribution unit and the fronthaul multiplexer when the sleep detection unit detects the migration of the communication station to the sleep state.

### TECHNICAL FIELD

The present invention relates to a control device, a fronthaul multiplexer, a connection switching method, and a multiplex method.

### BACKGROUND ART

FIG. 11 is a diagram showing one example of a conventional communication system S. The communication system S includes a plurality of antenna stations 1-1 and 1-2, a fronthaul multiplexer 2, and an aggregation station 3. The antenna stations 1-1 and 1-2 are RUs (Radio Unit) in a mobile communication system. The aggregation station 3 is a CU/DU (Central Unit/Distributed Unit) in the mobile communication system. As shown in FIG. 11, in order to effectively utilize frequency resources of a radio section and the aggregation station 3 that performs the base-band processing, a device called a FrontHaul Multiplexer (FHM) 2 is arranged between the antenna stations 1-1 and 1-2 installed at different locations.

The fronthaul multiplexer 2 behaves in such a way that the plurality of antenna stations 1-1 and 1-2 connected to the fronthaul multiplexer 2 appears to be one antenna station when viewed from the aggregation station 3. Specifically, the fronthaul multiplexer 2 performs signal processing on signals corresponding to the same time point on uplink signals received from the plurality of antenna stations 1-1 and 1-2 and merges the signals. Depending on a distance between the fronthaul multiplexer 2 and each of the antenna stations 1-1 and 1-2, a time point at which each of the uplink signals is received by the fronthaul multiplexer 2 differs. For this, the fronthaul multiplexer 2 imparts a delay corresponding to the distance difference to the received uplink signal, merges the signals, and then performs signal processing.

FIG. 12 is a diagram for explaining an outline of processing performed by the fronthaul multiplexer 2. As shown in FIG. 12, it is assumed that the uplink signal transmitted from the antenna station 1-1 reaches the fronthaul multiplexer 2 before the uplink signal transmitted from the antenna station 1-2 depending on the distance between the fronthaul multiplexer 2 and each of the antenna stations 1-1 and 1-2. In this case, the fronthaul multiplexer 2 adjusts the receiving time points of the uplink signals transmitted from the respective antenna stations 1-1 and 1-2 by imparting the delay to the uplink signal transmitted from the antenna station 1-1. Thereafter, the fronthaul multiplexer 2 generates a multiplex signal by multiplexing the uplink signals transmitted from the respective antenna stations 1-1 and 1-2.

In this way, by using the fronthaul multiplexer 2, the number of required ports for the aggregation station 3 and the number of required fibers between the fronthaul multiplexer 2 and the aggregation station 3 can be reduced. The fronthaul multiplexer 2 adds (or selects) the signal (the one obtained by quantizing the received power) received by the antenna in the uplink direction and makes them appear to be received signals from a single antenna. For this, it is necessary to adjust the sampling time point so that the sampling time point does not deviate at the time of addition. Note that a 5G fronthaul multiplexer 2 has also been developed.

### CITATION LIST

### Non Patent Literature

[NPL 1] “Development of Base Station Device for Introduction of 3.5 GHz Band TD-LTE”, NTT DOCOMO Technical Journal Vol. 24 No. 2

[NPL 2] “5G Network”, NTT DOCOMO Technical Journal, Vol. 28 No. 2

[NPL 3] “Mobile Fronthaul over APN PoC Reference Version 1.0”, Aug. 29, 2022, IOWN GLOBAL FORUM™

### SUMMARY OF INVENTION

### Technical Problem

By the way, at night when a traffic amount is significantly reduced compared with daytime, power consumed by the aggregation station can be reduced by stopping the aggregation station accommodating an antenna station with a small traffic amount and changing the connection to another aggregation station by switching a route of an optical distribution unit like an optical switch. However, on the assumption that a relationship between the antenna station and the aggregation station is a one-to-one basis, only the location where the aggregation station is provided changes, the number of required aggregation stations does not change, and there is a problem that an effect of power reduction cannot be expected.

In view of the above-described circumstances, an object of the present invention is to provide a technique that can reduce power consumption of an entire system.

### Solution to Problem

One aspect of the present invention is a control device including a sleep detection unit that detects a migration of a communication station, which is connected to a first path via an optical distribution unit that outputs signals outputted from one or more terminal accommodation stations to another path and not via a fronthaul multiplexer that multiplexes and outputs signals outputted from the one or more terminal accommodation stations, to a sleep state among a plurality of communication stations that accommodates the one or more terminal accommodation stations that communicate with a terminal, and a switching signal transmission unit that transmits a switching signal to the optical distribution unit that instructs to switch the terminal accommodation station accommodated in the communication station that has migrated to the sleep state to be accommodated in the communication station connected to a second path via the optical distribution unit and the fronthaul multiplexer when the sleep detection unit detects the migration of the communication station to the sleep state.

One aspect of the present invention is a fronthaul multiplexer in a communication system including a plurality of terminal accommodation stations that communicates with a terminal, an optical distribution unit that outputs each signal outputted from the plurality of terminal accommodation stations to a distribution destination, and a fronthaul multiplexer that multiplexes and outputs each signal outputted from the optical distribution unit, the fronthaul multiplexer includes a switching notification receiving unit that receives information on a delay time required for transfer between the terminal accommodation station to which connection is to be switched and the optical distribution unit and information on the terminal accommodation station to which the connection is to be switched, a delay adjustment unit that adjusts timing at which each signal received via the optical distribution unit is transmitted by imparting a delay to a signal outputted from the terminal accommodation station specified by the information on the terminal accommodation station to which the connection is to be switched on the basis of the information on the delay time received by the switching notification receiving unit, and a signal merging unit that multiplexes and outputs the signal outputted after being adjusted by the delay adjustment unit and the signal outputted from another terminal accommodation station.

One aspect of the present invention is a connection switching method that includes detecting a migration of a communication station, which is connected to a first path via an optical distribution unit that outputs signals outputted from one or more terminal accommodation stations to another path and not via a fronthaul multiplexer that multiplexes and outputs signals outputted from the one or more terminal accommodation stations, to a sleep state among a plurality of communication stations that accommodates the one or more terminal accommodation stations that communicate with a terminal, and transmitting a switching signal to the optical distribution unit that instructs to switch the terminal accommodation station accommodated in the communication station that has migrated to the sleep state to be accommodated in the communication station connected to a second path via the optical distribution unit and the fronthaul multiplexer when detecting the migration of the communication station to the sleep state.

One aspect of the present invention is a multiplex method performed by a fronthaul multiplexer in a communication system including a plurality of terminal accommodation stations that communicates with a terminal, an optical distribution unit that outputs each signal outputted from the plurality of terminal accommodation stations to a distribution destination, and a fronthaul multiplexer that multiplexes and outputs each signal outputted from the optical distribution unit, the multiplex method includes receiving information on a delay time required for transfer between the terminal accommodation station to which connection is to be switched and the optical distribution unit and information on the terminal accommodation station to which the connection is to be switched, adjusting timing at which each signal received via the optical distribution unit is transmitted by imparting a delay to a signal outputted from a terminal accommodation station specified by the information on the terminal accommodation station to which the connection is to be switched on the basis of the information on the received delay time, and multiplexing and outputting the signal outputted after being adjusted and the signal outputted from another terminal accommodation station.

### Advantageous Effects of Invention

According to the present invention, it is possible to reduce the power consumption of the entire system.

### BRIEF DESCRIPTION OF DRAWINGS

FIG. 1 A diagram showing a configuration example of a communication system according to a first embodiment.

FIG. 2 A diagram showing a configuration example of an optical distribution unit connection table according to the first embodiment.

FIG. 3 A diagram for explaining a switching of a connection relationship of the optical distribution unit according to the first embodiment.

FIG. 4 A sequence diagram showing a flow of processing of the communication system according to the first embodiment.

FIG. 5 A diagram showing a configuration example of a communication system of a modification example according to the first embodiment.

FIG. 6 A diagram for explaining a switching of a connection relationship of the optical distribution unit according to a second embodiment.

FIG. 7 A diagram showing a configuration example of a communication system according to a third embodiment.

FIG. 8 A diagram showing a configuration example of an optical distribution unit connection table according to the third embodiment.

FIG. 9 A diagram showing a configuration example of an insertion delay table according to the third embodiment.

FIG. 10 A diagram for explaining a switching of a connection relationship of the optical distribution unit according to the third embodiment.

FIG. 11 A diagram showing one example of a conventional communication system.

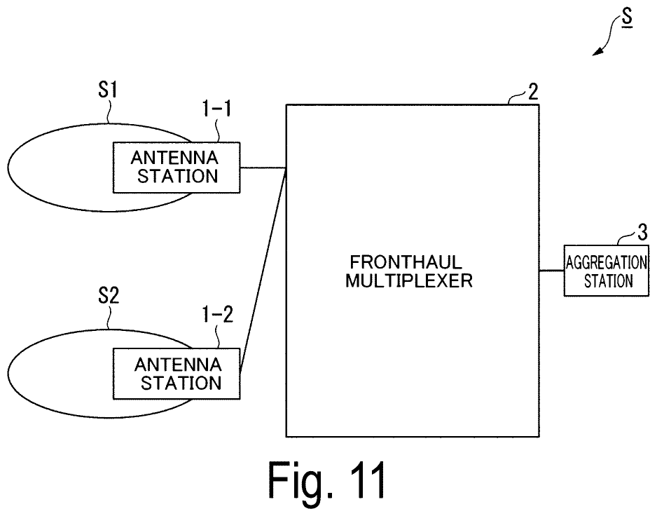

FIG. 12 A diagram for explaining an outline of processing performed by a fronthaul multiplexer.

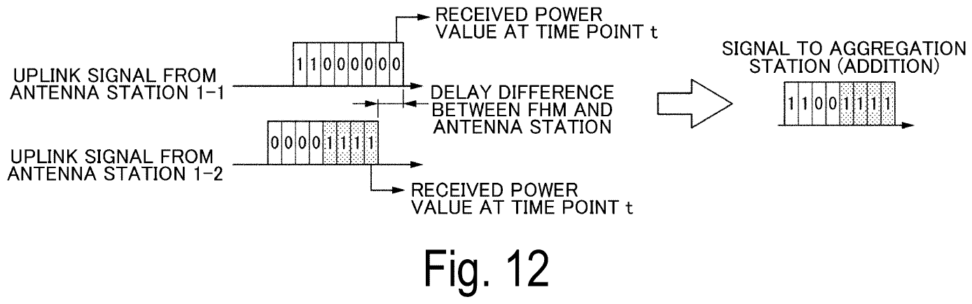

### DESCRIPTION OF EMBODIMENTS

Hereinafter, one embodiment of the present invention will be described with reference to the drawings.

### First Embodiment

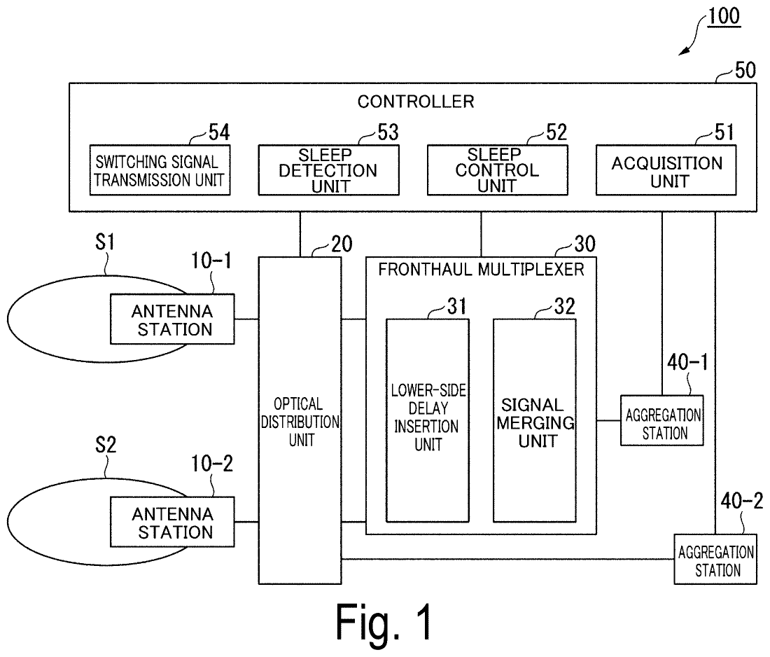

FIG. 1 is a diagram showing a configuration example of a communication system 100 according to a first embodiment. The communication system 100 includes one or more antenna stations 10, an optical distribution unit 20, a fronthaul multiplexer 30, one or more aggregation stations 40, and a controller 50. Although FIG. 1 shows the case where the communication system 100 includes two antenna stations 10-1 to 10-2 and two aggregation stations 40-1 to 40-2, the number of the antenna stations 10 and aggregation stations 40 is not particularly limited.

In the following description, the antenna stations 10-1 to 10-2 are described as the antenna station 10 if they are not particularly distinguished, and the aggregation stations 40-1 to 40-2 are described as the aggregation station 40 if they are not particularly distinguished. Hereinafter, the direction from the antenna station 10 to the aggregation station 40 will be described as the uplink direction.

An optical transmission line connects the antenna stations 10-1 and 10-2 to the optical distribution unit 20, the optical distribution unit 20 to the fronthaul multiplexer 30, the fronthaul multiplexer 30 to the aggregation station 40-1, and the optical distribution unit 20 to the aggregation station 40-2. The optical transmission line is an optical fiber and transmits an optical signal, for example. An electric line for transmitting an electric signal connects the controller 50 to the optical distribution unit 20, and the controller 50 to the aggregation stations 40-1 and 40-2.

In FIG. 1, it is assumed that the antenna station 10-1 is accommodated in the aggregation station 40-1 via the optical distribution unit 20 and the fronthaul multiplexer 30, and the antenna station 10-2 is accommodated in the aggregation station 40-2 via the optical distribution unit 20. The fronthaul multiplexer 30 is accommodated in the aggregation station 40-1.

The antenna station 10 communicates with one or more terminals located in cells S1, S2, and S3 representing a communication possible range. The antenna station 10-1 communicates with one or more terminals located in the cell S1, for example. Similarly, the antenna station 10-2 communicates with one or more terminals located in the cell S2, for example. The antenna station 10 receives the uplink signal transmitted from one or more terminals. The antenna station 10 is an RU in a mobile communication system. The antenna station 10 is one aspect of a terminal accommodation station.

The optical distribution unit 20 has a plurality of first ports and a plurality of second ports, and is an optical distribution device that outputs the optical signals inputted from one port to another port. The plurality of antenna stations 10 is connected to the plurality of first ports of the optical distribution unit 20, and the fronthaul multiplexer 30 and the aggregation station 40-2 are connected to the plurality of second ports of the optical distribution unit 20. The optical distribution unit 20 switches the connection so that each of the antenna stations 10 is accommodated in the fronthaul multiplexer 30 according to control of the controller 50. For example, the optical distribution unit 20 switches the first port to which the antenna station 10-2 is connected from the second port to which the aggregation station 40-2 is connected to the second port to which the fronthaul multiplexer 30 is connected. Therefore, the optical distribution unit 20 accommodates each of the antenna stations 10 in the fronthaul multiplexer 30. The optical distribution unit 20 may be an optical switch, a multicast switch, or other switches.

The fronthaul multiplexer 30 behaves in such a way that the plurality of connected antenna stations 10 appears to be one antenna station 10 when viewed from the aggregation station 40. The fronthaul multiplexer 30 receives the uplink signal transmitted from each of the antenna stations 10. The fronthaul multiplexer 30 merges each uplink signal by performing signal processing on the signal corresponding to the same time point to each received uplink signal. Therefore, the fronthaul multiplexer 30 generates the multiplex signal. The fronthaul multiplexer 30 outputs the generated multiplex signal to the aggregation station 40-1.

The aggregation station 40-1 processes the multiplex signal output from the fronthaul multiplexer 30 or transfers it to a higher one. In this way, the aggregation station 40-1 is connected to a path via the optical distribution unit 20 and the fronthaul multiplexer 30. The aggregation station 40-2 processes the uplink signal transferred from the optical distribution unit 20 or transfers it to a higher one. In this way, the aggregation station 40-2 is connected to a path via the optical distribution unit 20 and not via the fronthaul multiplexer 30. Further, the aggregation station 40-2 migrates to a sleep state in response to an instruction from the controller 50. The sleep state is a function in which power can be saved by stopping some functions.

The aggregation stations 40-1 and 40-2 are DUs in the mobile communication system. Although FIG. 1 shows the case where the number of aggregation stations 40 connected to the path via the fronthaul multiplexer 30 is one and the number of aggregation stations 40 connected to the path via the optical distribution unit 20 and not via the fronthaul multiplexer 30 is one, the number of aggregation stations 40 connected to each path is not particularly limited. The aggregation station 40 is one aspect of a communication station.

The controller 50 controls the entire communication system 100. The controller 50 acquire determination information used for sleep control of the aggregation stations 40 from each of the plurality of aggregation stations 40. The determination information includes a traffic amount, the number of connected terminals, a traffic distribution amount, an allocation amount, radio quality information such as CQI (Channel Quality Indicator), degree of priority information such as 5QI that communicates, and information on contract services, for example. The following description will be performed on the assumption that the determination material is the traffic amount.

When determined that the aggregation station 40 (hereinafter referred to as “sleep target aggregation station”) to be a sleep target can be migrated to the sleep state on the basis of the determination information, the controller 50 instructs the optical distribution unit 20 to switch. The sleep target aggregation station is the aggregation station 40 (for example, aggregation station 40-2) that is not connected to a path via the fronthaul multiplexer 30, for example. The controller 50 instructs the sleep target aggregation station to sleep before switching of the optical distribution unit 20 or after switching.

Next, the functions included in the fronthaul multiplexer 30 and the controller 50 will be described in detail. First, the functions of the fronthaul multiplexer 30 will be described. The fronthaul multiplexer 30 includes a lower-side delay insertion unit 31 and a signal merging unit 32.

The lower-side delay insertion unit 31 receives each uplink signal transferred from the optical distribution unit 20. The lower-side delay insertion unit 31 imparts a delay to at least some of the received uplink signals to make them signals received at the same time point. Here, imparting a delay means inserting a delay to a signal and delaying it. The lower-side delay insertion unit 31 imparts the delay corresponding to the distance difference to the uplink signal, for example.

The signal merging unit 32 generates the multiplex signal by multiplexing each uplink signal including the uplink signal to which the delay is imparted by the lower-side delay insertion unit 31.

Next, the functions included in the controller 50 will be described. The controller 50 includes an acquisition unit 51, a sleep control unit 52, a sleep detection unit 53, and a switching signal transmission unit 54.

The acquisition unit 51 acquires the determination information from each of the plurality of aggregation stations 40. The acquisition unit 51 acquires the determination information from each of the plurality of aggregation stations 40 at predetermined timing or periodically, for example. The acquisition unit 51 outputs the acquired determination information of each aggregation station 40 to the sleep control unit 52.

The sleep control unit 52 determines whether or not the aggregation station 40 can be asleep on the basis of the determination information of each aggregation station 40 acquired by the acquisition unit 51. The sleep control unit 52 determines whether or not the sleep target aggregation station can be asleep, for example.

### Determination of Whether or Not to Allow Sleep When Determination Information is Traffic Amount

When the determination information is the traffic amount, the sleep control unit 52 determines that the sleep target aggregation station can be asleep when the traffic amount of the sleep target aggregation station remains less than a first threshold value for a predetermined period of time or longer and when another aggregation station 40 can accommodate the traffic of the sleep target aggregation station.

On the other hand, the sleep control unit 52 determines that the sleep target aggregation station cannot be asleep when the traffic amount of the sleep target aggregation station is equal to or greater than the first threshold value. Alternatively, the sleep control unit 52 may determine that the sleep target aggregation station cannot be asleep when the period in which the traffic amount of the sleep target aggregation station becomes less than the first threshold value does not continue for the predetermined period or longer. Alternatively, the sleep control unit 52 may determine that the sleep target aggregation station cannot be asleep when another aggregation station 40 cannot accommodate the traffic of the sleep target aggregation station even if the period in which the traffic amount of the sleep target aggregation station becomes less than the first threshold value continues for the predetermined period or longer.

### Determination of Whether or Not to Allow Sleep When Determination Information is Number of Connection Terminals

When the determination information is the number of connection terminals, the sleep control unit 52 determines that the sleep target aggregation station can be asleep when the number of connection terminals (for example, the number of antenna stations 10) of the sleep target aggregation station is less than a predetermined criterion and another aggregation station 40 can accommodate the connection terminals of the sleep target aggregation station.

On the other hand, the sleep control unit 52 determines that the sleep target aggregation station cannot be asleep when the number of connection terminals of the sleep target aggregation station is equal to or greater than the predetermined criterion. Alternatively, the sleep control unit 52 may determine that the sleep target aggregation station cannot be asleep when another aggregation station 40 cannot accommodate the connection terminals of the sleep target aggregation station even if the number of connection terminals of the sleep target aggregation station becomes less than the predetermined criterion.

When determining that the sleep is possible, the sleep control unit 52 notifies the sleep detection unit 53 to make the sleep target aggregation station asleep. Further, when determining that the sleep is possible, the sleep control unit 52 transmits a sleep instruction to the sleep target aggregation station. The sleep instruction is an instruction for executing the migration to the sleep state.

The sleep detection unit 53 detects the migration of the sleep target aggregation station to the sleep state in response to the notification from the sleep control unit 52. The sleep detection unit 53 detects the migration of the aggregation station 40-2 connected to the path via the optical distribution unit 20 and not via the fronthaul multiplexer 30 to the sleep state, for example.

When the sleep detection unit 53 detects the migration of the sleep target aggregation station to the sleep state, the switching signal transmission unit 54 transmits a switching signal including an instruction to switch an accommodation destination of the antenna station 10 to the optical distribution unit 20. The switching signal includes information indicating the port to which the aggregation station 40 to be the switching destination is connected, for example. The switching signal transmission unit 54 acquires information included in the switching signal from the optical distribution unit connection table, for example. The optical distribution unit connection table is a table in which information about the connection of the optical distribution unit 20 is registered. The details of the optical distribution unit connection table will be described later. The optical distribution unit connection table is stored in a memory that is not shown by drawings.

When the migration of the sleep target aggregation station to the sleep state is detected, the switching signal transmission unit 54 transmits the switching signal to the optical distribution unit 20 that instructs to switch the antenna station 10 accommodated in the sleep target aggregation station to be accommodated by the aggregation station 40 connected to the path via the optical distribution unit 20 and the fronthaul multiplexer 30, for example.

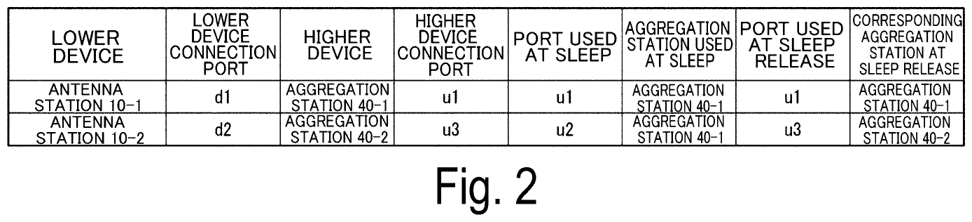

FIG. 2 is a diagram showing a configuration example of the optical distribution unit connection table according to the first embodiment. The optical distribution unit connection table has a plurality of records in which information about the connection of the optical distribution unit 20 is registered. Each record has values of a lower device, a lower device connection port, a higher device, a higher device connection port, a port used at sleep, an aggregation station used at sleep, a port used at sleep release, and a corresponding aggregation station at sleep release. The lower device represents a lower device connected to the optical distribution unit 20. The lower device connected to the optical distribution unit 20 is the antenna station 10, for example. The lower device connection port represents the first port of the optical distribution unit 20 to which the lower device is connected.

A higher device represents a higher device connected to the optical distribution unit 20. The higher device connected to the optical distribution unit 20 is the aggregation station 40, for example. The higher device connection port represents the second port of the optical distribution unit 20 to which the higher device is connected. The port used at sleep represents the second port of the optical distribution unit 20 used as a connection destination of the antenna station 10 when the aggregation station 40 is asleep. The aggregation station used at sleep represents the aggregation station 40 used as a connection destination of the antenna station 10 when the aggregation station 40 is asleep. The port used at sleep release represents the second port of the optical distribution unit 20 used as a connection destination of the antenna station 10 when the aggregation station 40 releases the sleep. The corresponding aggregation station at sleep release represents the aggregation station 40 used as a connection destination of the antenna station 10 when the aggregation station 40 releases the sleep.

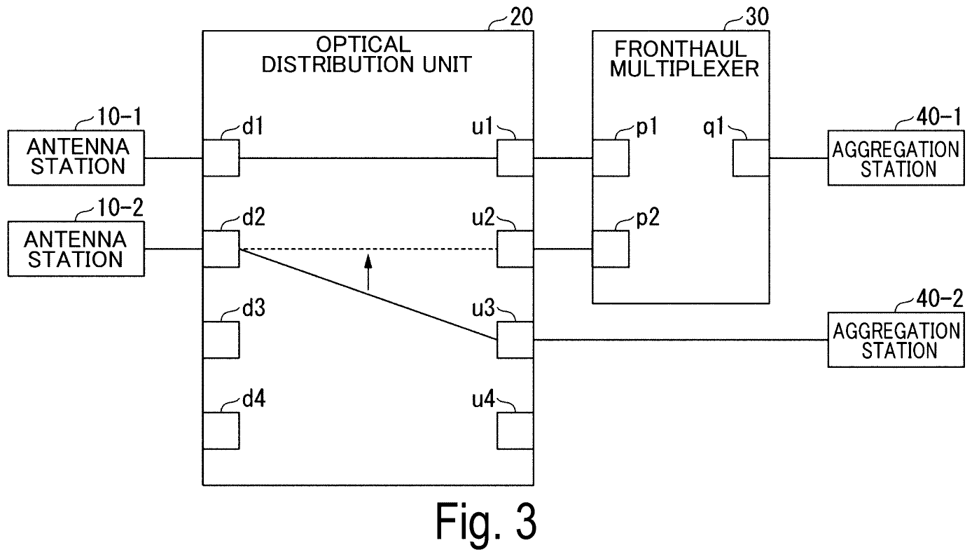

FIG. 3 is a diagram for explaining the switching of the connection relationship of the optical distribution unit 20 according to the first embodiment. In FIG. 3, as one example, a configuration is described, in which the optical distribution unit 20 has four first ports d1 to d4 and four second ports u1 to u4, and the fronthaul multiplexer 30 has two first ports p1 to p2 and one second port q1. Note that the number of ports included in the optical distribution unit 20 and the fronthaul multiplexer 30 is not limited to the example shown in FIG. 3.

As shown in FIG. 3, the antenna station 10-1 is connected to the first port d1 of the optical distribution unit 20, the antenna station 10-2 is connected to the first port d2 of the optical distribution unit 20, the fronthaul multiplexer 30 is connected to the second ports u1 and u2 of the optical distribution unit 20, and the aggregation station 40-2 is connected to the second port u3 of the optical distribution unit 20. The optical distribution unit 20 is connected to the first ports p1 and p2 of the fronthaul multiplexer 30, and the aggregation station 40-1 is connected to the second port q1 of the fronthaul multiplexer 30. Inside the optical distribution unit 20, the first port d1 and the second port u1 are connected, and the first port d2 and the second port u3 are connected.

Here, a flow of connection switching of the optical distribution unit 20 by using the connection relationship shown in FIG. 3 as an example will be described using the optical distribution unit connection table shown in FIG. 2. When the sleep detection unit 53 detects the migration of the aggregation station 40-2 to the sleep state, the switching signal transmission unit 54 refers to the optical distribution unit connection table to grasp that the aggregation station 40-2 is connected to the second port u3 of the optical distribution unit 20. Further, the switching signal transmission unit 54 grasps that the antenna station 10-2 accommodated in the aggregation station 40-2 is connected to the first port d2 of the optical distribution unit 20.

Thereafter, the switching signal transmission unit 54 refers to the items of the port used at sleep and the aggregation station used at sleep in the optical distribution unit connection table to grasp that the connection destination of the antenna station 10-2 is the aggregation station 40-1 and utilization of the second port u2 of the optical distribution unit 20 toward the aggregation station 40-1 when the aggregation station 40-2 is asleep. Therefore, the switching signal transmission unit 54 generates the switching signal instructing to switch the connection connected from the first port d2 of the optical distribution unit 20 to the second port u3 of the optical distribution unit 20 to a connection connected from the first port d2 of the optical distribution unit 20 to the second port u2 of the optical distribution unit 20. The switching signal transmission unit 54 transmits the generated switching signal to the optical distribution unit 20. Therefore, the optical distribution unit 20 switches the connection so as to connect the first port d2 and the second port u2 as shown by a dotted line in FIG. 3.

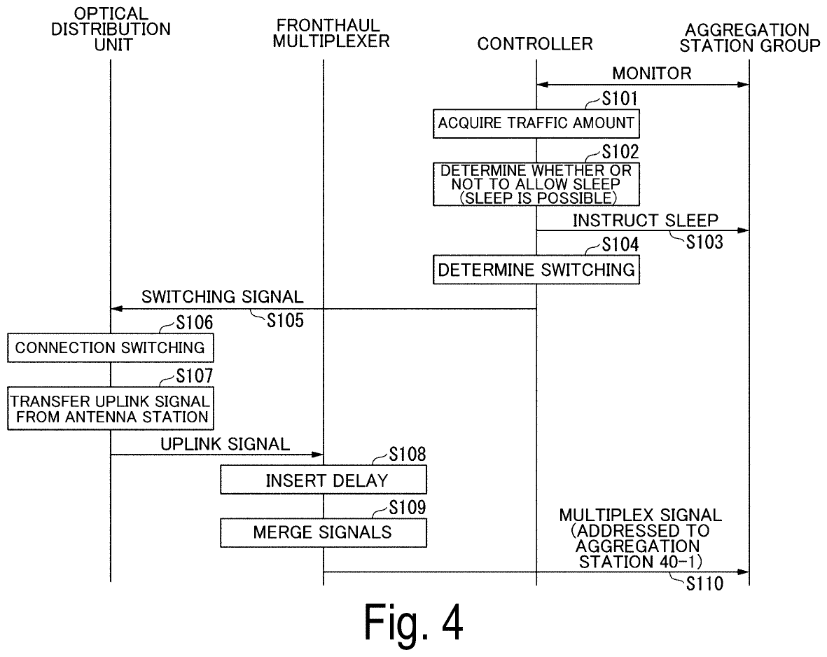

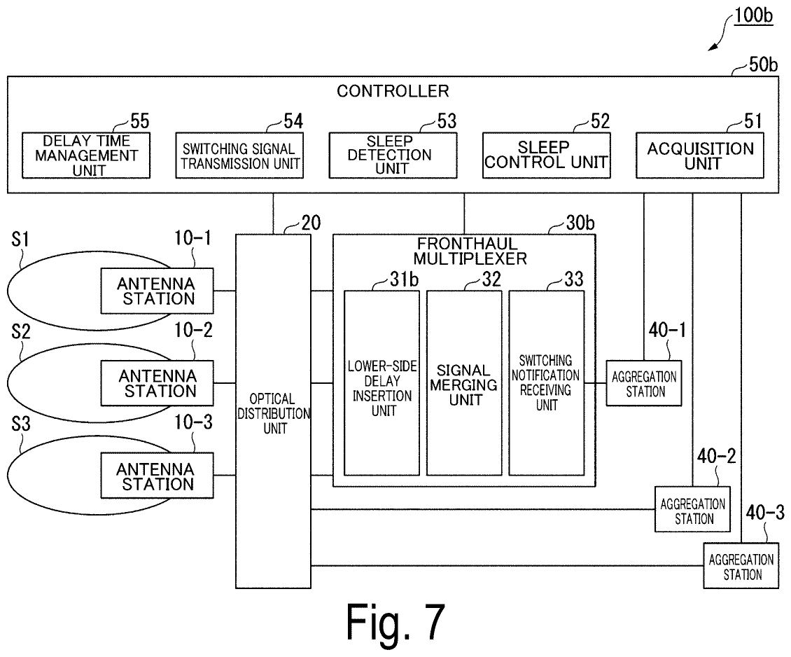

FIG. 4 is a sequence diagram showing a flow of processing of the communication system 100 according to the first embodiment. In FIG. 4, the aggregation stations 40-1 and 40-2 are collectively described as aggregation station group, but will be described as aggregation station 40-1 or 40-2 as needed. At the start of the processing in FIG. 7, it is assumed that the antenna station 10-1 is connected to the aggregation station 40-1 via the optical distribution unit 20 and the fronthaul multiplexer 30, and the antenna station 10-2 is connected to the aggregation station 40-2 via the optical distribution unit 20. As one example, it is assumed that 10 terminal devices are connected to the aggregation station 40-2 via the antenna station 10-2, and the total traffic amount passing through the aggregation station 40-2 flows by 10% or more of the amount (for example, 1 Gbps) that can be processed by the aggregation station 40-2.

The acquisition unit 51 of the controller 50 acquires information on the traffic amount of each aggregation station 40 (step S101). Note that, it is assumed that the number of terminal devices connected to the aggregation station 40-2 via the antenna station 10-2 is two before the acquisition unit 51 acquires the information on the traffic amount of each aggregation station 40. Therefore, it is assumed that the average traffic flowing through the aggregation stations 40-2 is 5%=50 Mbps or less of the traffic that can be processed by the aggregation stations 40-1 and 40-2. The acquisition unit 51 outputs the acquired information on the traffic amount of each aggregation station 40 to the sleep control unit 52.

The sleep control unit 52 determines whether or not to allow sleep on the basis of the information on the traffic amount of each aggregation station 40 outputted from the acquisition unit 51 (step S102). For example, the sleep control unit 52 determines whether or not the aggregation station 40-2 can be asleep on the basis of information on the traffic amount of the aggregation station 40-2. Here, it is assumed that the sleep control unit 52 determines that the aggregation station 40-2 can be asleep. In this case, the sleep control unit 52 transmits the sleep instruction to the aggregation station 40-2 (step S203). Therefore, the aggregation station 40-2 can be migrated to the sleep state.

Note that if the aggregation station 40-2 is migrated to the sleep state before the optical distribution unit 20 performs the switching, signals transmitted from the antenna station 10-2 which is connected to the aggregation station 40-2 could be lost. Thus, the sleep control unit 52 may transmit the sleep instruction to the aggregation station 40-2 after switching is performed by the optical distribution unit 20.

Further, the sleep control unit 52 notifies the sleep detection unit 53 to make the aggregation station 40-2 asleep. The sleep detection unit 53 detects the migration of the aggregation station 40-2 to the sleep state by the notification from the sleep control unit 52. The sleep detection unit 53 determines that the switching is required in accordance with the detection of the migration of the aggregation station 40-2 to the sleep state (step S104). The sleep detection unit 53 notifies that the connection switching of the optical distribution unit 20 is necessary and that the aggregation station 40-2 migrates to the sleep state.

The switching signal transmission unit 54 generates the switching signal in response to the notification from the sleep detection unit 53. Specifically, the switching signal transmission unit 54 refers to the optical distribution unit connection table to generate the switching signal that instructs to switch the connection connected from the first port d2 of the optical distribution unit 20 to the second port u3 of the optical distribution unit 20 to the connection from the first port d2 of the optical distribution unit 20 to the second port u2 of the optical distribution unit 20. The switching signal transmission unit 54 transmits the generated switching signal to the optical distribution unit 20 (step S105).

The optical distribution unit 20 receives the switching signal transmitted from the controller 50. The optical distribution unit 20 switches the connection between ports on the basis of the received switching signal (step S106). For example, the optical distribution unit 20 switches the connection so as to connect the first port d2 and the second port u2. By switching the connection, the antenna stations 10-1 and 10-2 are accommodated in the aggregation station 40-1. Thereafter, it is assumed that the uplink signal is transmitted from each of the antenna stations 10-1 and 10-2.

The optical distribution unit 20 inputs the uplink signals transmitted from each of the antenna stations 10-1 and 10-2 from the first port, and outputs the inputted uplink signals from the second port. The first port of the optical distribution unit 20 to which the antenna stations 10-1 and 10-2 are connected, respectively, is connected to the second port to which the fronthaul multiplexer 30 is connected. Therefore, each uplink signal inputted to the optical distribution unit 20 is transferred to the fronthaul multiplexer 30.

The fronthaul multiplexer 30 receives each uplink signal transferred from the optical distribution unit 20. The distance from the antenna station 10-1 to the fronthaul multiplexer 30 is often different from the distance from the antenna station 10-2 to the fronthaul multiplexer 30 and the antenna stations 10-1 and 10-2 transmit uplink signals at different timing, respectively. For this, the uplink signals transmitted from the respective antenna stations 10-1 and 10-2 are received at different timing in the fronthaul multiplexer 30.

The lower-side delay insertion unit 31 of the fronthaul multiplexer 30 inserts a delay into some of each of the received uplink signals (step S108). Note that the insertion of the delay is the same as that in the prior art. The lower-side delay insertion unit 31 outputs each uplink signal including the uplink signal to which the delay is imparted to the signal merging unit 32. The signal merging unit 32 multiplexes each uplink signal including the uplink signal to which the delay is imparted by the lower-side delay insertion unit 31 to generate a multiplex signal (step S109). The signal merging unit 32 outputs the generated multiplex signal to the aggregation station 40-1 (step S110). The aggregation station 40-1 receives the multiplex signal outputted from the optical distribution unit 20. Thereafter, the aggregation station 40-1 processes the received multiplex signal or transfers it to the higher one.

The communication system 100 configured as described above includes the sleep detection unit 53 that detects the migration of the aggregation station 40-2 connected to the first path via the optical distribution unit 20 and not via the fronthaul multiplexer 30 to the sleep state among the plurality of aggregation stations 40 and the switching signal transmission unit 54 that transmits the switching signal to the optical distribution unit 20 that instructs to switch the antenna station 10-2 accommodated in the aggregation station 40-2 that has migrated to the sleep state to be accommodated in the aggregation station 40 connected to the second path via the optical distribution unit 20 and the fronthaul multiplexer 30 when the sleep detection unit 53 detects the migration of the aggregation station 40-2 to the sleep state.

In this way, when the load on the aggregation station 40 is reduced to allow sleep (for example, traffic amount is reduced), the connection is switched so that the antenna station 10 connected to the aggregation station 40 that can sleep is accommodated in the aggregation station 40 connected to the fronthaul multiplexer 30. After switching the connection by the optical distribution unit 20, the delay insertion and signal merging are performed through the fronthaul multiplexer 30, so that the signals of the antenna station 10-1 and the antenna station 10-2 are multiplexed and accommodated in one port of the aggregation station 40-1. Accordingly, when the load on the aggregation station 40 connected to the antenna station 10 on a one-to-one basis decreases, the signal processing of the antenna station 10 can be aggregated to the aggregation station 40 connected to the fronthaul multiplexer 30 for multiplexing signals of the plurality of antenna stations 10. Therefore, it is not necessary to prepare extra ports or other aggregation stations 40 additionally on the aggregation station 40-1 side. For this, the aggregation station 40-2 can be allowed to sleep, and power consumption of the entire system can be reduced as compared with switching the aggregation station 40 connected to the antenna station 10 in a one-to-one basis.

Further, since the switching is performed when the load on the aggregation station 40 is low enough to allow sleep, the influence of depletion of the band on the user can be reduced even after the aggregation via the fronthaul multiplexer 30 is performed.

### Modification Example of First Embodiment

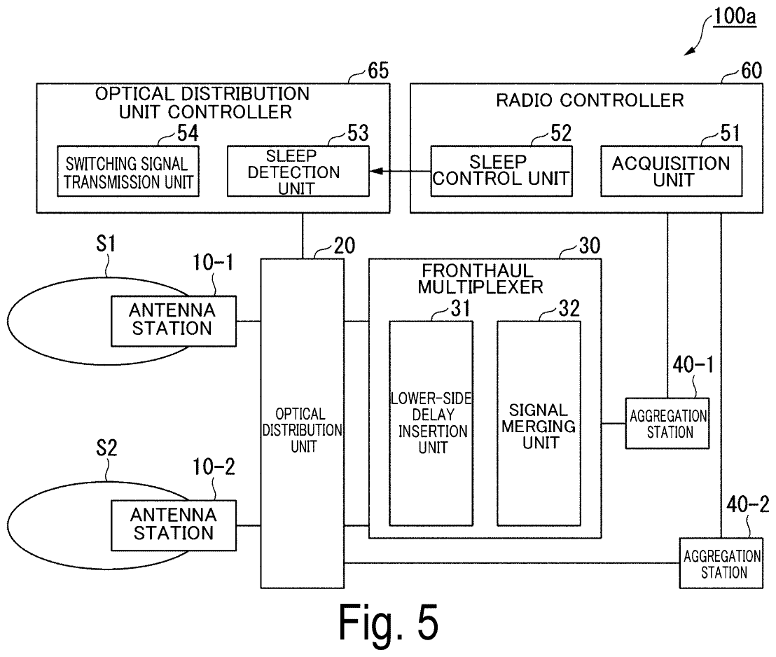

In the above-mentioned embodiment, the controller 50 determines whether or not to allow the sleep and issues the switching instruction to the optical distribution unit 20. It may be configured to determine whether or not to allow the sleep and issue the switching instruction to the optical distribution unit 20 by different devices. FIG. 5 is a diagram showing a configuration example of a communication system 100a according to a modification example of the first embodiment. The communication system 100a includes one or more antenna stations 10, an optical distribution unit 20, a fronthaul multiplexer 30, one or more aggregation stations 40, a radio controller 60, and an optical distribution unit controller 65. Although FIG. 5 shows the case where the communication system 100a includes two antenna stations 10-1 to 10-2 and two aggregation stations 40-1 to 40-2, the number of the antenna stations 10 and aggregation stations 40 is not particularly limited.

The communication system 100a is different in configuration from the communication system 100 in that it includes the radio controller 60 and the optical distribution unit controller 65 in place of the controller 50. The other configurations of the communication system 100a are the same as those of the communication system 100. Hereinafter, the difference will be mainly described. The radio controller 60 performs radio communication with the aggregation station 40 and with the optical distribution unit controller 65. The radio controller 60 includes an acquisition unit 51 and a sleep control unit 52.

The acquisition unit 51 included in the radio controller 60 acquires the determination information from each of the plurality of aggregation stations 40 by radio. The acquisition unit 51 acquires the determination information from each of the plurality of aggregation stations 40 at predetermined timing or periodically by radio, for example. The acquisition unit 51 outputs the acquired determination information of each aggregation station 40 to the sleep control unit 52. The sleep control unit 52 included in the radio controller 60 determines whether or not the aggregation station 40 can be asleep on the basis of the determination information of each aggregation station 40 acquired by the acquisition unit 51.

When determined to allow sleep, the sleep control unit 52 notifies the optical distribution unit controller 65 that the sleep target aggregation station is made asleep by radio. Further, when determined to allow sleep, the sleep control unit 52 transmits the sleep instruction to the sleep target aggregation station by radio.

The optical distribution unit controller 65 controls the optical distribution unit 20. The optical distribution unit controller 65 includes a sleep detection unit 53 and a switching signal transmission unit 54. The sleep detection unit 53 included in the optical distribution unit controller 65 detects the migration of the sleep target aggregation station to the sleep state in response to the notification from the radio controller 60. When the sleep detection unit 53 detects the migration of the sleep target aggregation station to the sleep state, the switching signal transmission unit 54 included in the optical distribution unit controller 65 transmits the switching signal to the optical distribution unit 20. The switching operations of the optical distribution unit 20 by the switching signal transmission unit 54 is the same as the method shown in the first embodiment.

### Second Embodiment

In a second embodiment, a configuration of the case where the sleeping aggregation station is released from sleeping will be described. A system configuration and a device configuration according to the second embodiment are the same as those of the first embodiment. The difference from the first embodiment is the operation of the controller 50. Hereinafter, the difference will be mainly described. Note that, in the second embodiment, it is assumed that at least one aggregation station 40 (for example, aggregation station 40-2) is in the sleep state.

The sleep control unit 52 determines whether or not the sleep release of the sleeping aggregation station 40 is required on the basis of the determination information on each aggregation station 40 acquired by the acquisition unit 51. Hereinafter, the aggregation station 40 that is a sleep release target is referred to as a sleep release target aggregation station.

### Sleep Release Determination When Determination Information is Traffic Amount

When the determination information is the traffic amount, the sleep control unit 52 determines that the sleep release of the sleep release target aggregation station is required when the traffic amount of the aggregation station 40 that is not in the sleep state becomes a second threshold value or more. On the other hand, when the traffic amount of the aggregation station 40 that is not in the sleep state is less than the second threshold value, the sleep control unit 52 determines that the sleep release of the sleep release target aggregation station is not required.

### Determination of Whether or Not to Allow Sleep When Determination Information is Number of Connection Terminals

When the determination information is the number of connection terminals, the sleep control unit 52 determines that the sleep release of the sleep release target aggregation is required when the number of connection terminals (for example, the number of antenna stations 10) of the aggregation station 40 that is not in the sleep state becomes a predetermined criterion or more. On the other hand, when the number of connection terminals of the aggregation station 40 that is not in the sleep state is less than the predetermined criterion, the sleep control unit 52 determines that the sleep release of the sleep release target aggregation station is not required.

When determined that the sleep release is required, the sleep control unit 52 notifies the sleep detection unit 53 that the sleep release of the sleep release target aggregation station starts. Further, when determined that the sleep release is required, the sleep control unit 52 transmits the sleep release instruction to the sleep release target aggregation station. The sleep release instruction is an instruction to release the sleep state.

The sleep detection unit 53 detects the start of the sleep release of the sleep release target aggregation station in response to the notification from the sleep control unit 52. The sleep detection unit 53 detects the start of the sleep release of the aggregation station 40-2 connected to the path via the optical distribution unit 20 and not via the fronthaul multiplexer 30, for example.

When the sleep detection unit 53 detects the start of the sleep release of the sleep release target aggregation station, the switching signal transmission unit 54 transmits the switching signal including the instruction to switch the accommodation destination of the antenna station 10 to the optical distribution unit 20. The switching signal transmission unit 54 acquires information included in the switching signal from the optical distribution unit connection table, for example.

When the start of sleep release of the sleep release target aggregation station is detected, the switching signal transmission unit 54 transmits the switching signal to the optical distribution unit 20 that instructs to switch the antenna station 10 accommodated in the aggregation station 40 that is not sleeping to be accommodated in the aggregation station 40 connected to the path via the optical distribution unit 20 and not via the fronthaul multiplexer 30.

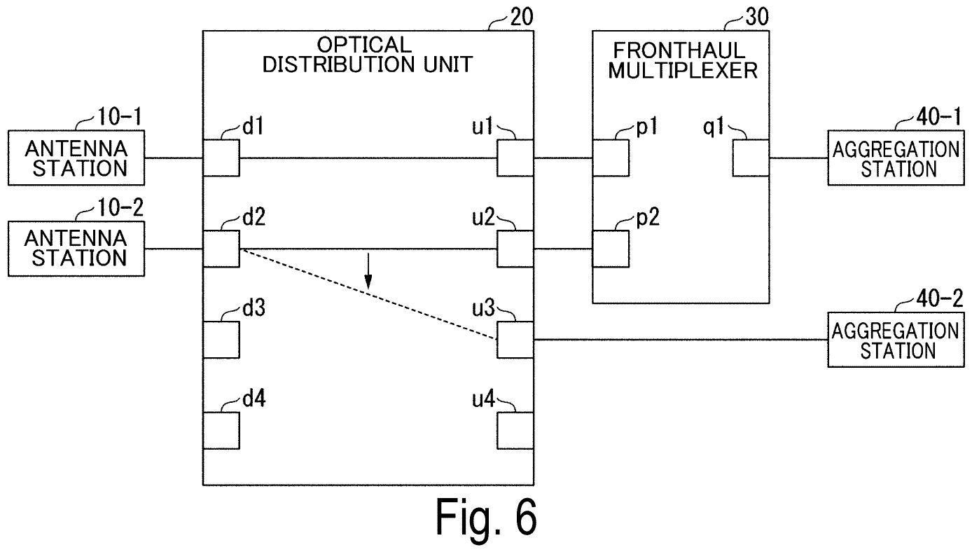

FIG. 6 is a diagram for explaining the switching of the connection relationship of the optical distribution unit 20 according to the second embodiment. In FIG. 6, the difference from FIG. 3 is that the first port dl and the second port u1 are connected to each other and the first port d2 and the second port u2 are connected to each other inside the optical distribution unit 20.

Here, a flow of connection switching of the optical distribution unit 20 by using the connection relationship shown in FIG. 6 as an example will be described using the optical distribution unit connection table shown in FIG. 2. When the sleep detection unit 53 detects the start of the sleep release of the aggregation station 40-2, the switching signal transmission unit 54 refers to the optical distribution unit connection table to grasp that the aggregation station 40-2 is connected to the second port u3 of the optical distribution unit 20. Further, the switching signal transmission unit 54 grasps that the antenna station 10-2 is connected to the first port d2 of the optical distribution unit 20.

Thereafter, the switching signal transmission unit 54 refers to the items of the port used at sleep release and the corresponding aggregation station at sleep release in the optical distribution unit connection table to grasp that the connection destination of the antenna station 10-2 is the aggregation station 40-2 and the second port u3 of the optical distribution unit 20 toward the aggregation station 40-2 is utilized when the sleep of the aggregation station 40-2 is released. Therefore, the switching signal transmission unit 54 generates the switching signal that instructs to switch the connection connected from the first port d2 of the optical distribution unit 20 to the second port u2 of the optical distribution unit 20 to a connection connected from the first port d2 of the optical distribution unit 20 to the second port u3 of the optical distribution unit 20. The switching signal transmission unit 54 transmits the generated switching signal to the optical distribution unit 20. Therefore, the optical distribution unit 20 switches connection so as to connect the first port d2 and the second port u3 as shown by a dotted line in FIG. 6.

According to the communication system 100 according to the second embodiment configured as described above, after the optical distribution unit 20 switches the connection, the antenna station 10-2 is connected to the aggregation station 40-2 again, so that the frequency resource of the aggregation station 40-2 which is not shared with the aggregation station 40-1 can be used. For this, even if the number of accommodated terminals increases, or a terminal with a large amount of communication or a terminal requiring low delay is accommodated, the service request can be satisfied.

Further, since it is possible to dynamically change whether or not to perform port aggregation to the fronthaul multiplexer 30 depending on the utilization situation, both efficient (high power efficiency) service provision and wide-band service provision can be achieved.

### Modification Example of Second Embodiment

In the above-mentioned embodiment, the controller 50 determines whether or not the sleep release is required and issues the switching instruction to the optical distribution unit 20. It may be configured to determine whether or not the sleep release is required and issue the switching instruction to the optical distribution unit 20 on different devices. When configured in this way, the communication system 100 according to the second embodiment includes a radio controller 60 and an optical distribution unit controller 65 in place of the controller 50 similarly to the modification example of the first embodiment. The radio controller 60 performs radio communication with the aggregation station 40 and with the optical distribution unit controller 65. The radio controller 60 includes an acquisition unit 51 and a sleep control unit 52.

The acquisition unit 51 included in the radio controller 60 acquires the determination information from each of the plurality of aggregation stations 40 by radio. The acquisition unit 51 acquires the determination information from each of the plurality of aggregation stations 40 at predetermined timing or periodically by radio, for example. The acquisition unit 51 outputs the acquired determination information of each aggregation station 40 to the sleep control unit 52. The sleep control unit 52 included in the radio controller 60 determines whether or not the sleep release of the sleep release target aggregation station is required on the basis of the determination information of each aggregation station 40 acquired by the acquisition unit 51. When determined that the sleep release is required, the sleep control unit 52 notifies the optical distribution unit controller 65 that the sleep release of the sleep release target aggregation station starts by radio. Further, when determined that the sleep release is required, the sleep control unit 52 transmits the sleep release instruction to the sleep release target aggregation station by radio.

The optical distribution unit controller 65 controls the optical distribution unit 20. The optical distribution unit controller 65 includes a sleep detection unit 53 and a switching signal transmission unit 54. The sleep detection unit 53 included in the optical distribution unit controller 65 detects the start of sleep release of the sleep release target aggregation station in response to the notification from the radio controller 60. When the sleep detection unit 53 detects the start of the sleep release target aggregation station, the switching signal transmission unit 54 included in the optical distribution unit controller 65 transmits the switching signal to the optical distribution unit 20. The switching operation of the optical distribution unit 20 by the switching signal transmission unit 54 is the same as the method shown in the second embodiment.

### Third Embodiment

In the first embodiment, when changing the aggregation station accommodating the antenna station to another aggregation station by switching the optical distribution unit, link disconnection occurs. Then, the distance between the antenna station and the aggregation station before the switching and the distance between the antenna station and the aggregation station after the switching are changed, so that the procedure for establishing the link including the delay measurement needs to be performed again between the antenna station and the aggregation station after the switching. For this, there is a problem that communication is disconnected during this period. Thus, in the third embodiment, a configuration for solving this problem will be described.

FIG. 7 is a diagram showing a configuration example of a communication system 100b according to a third embodiment. The communication system 100b includes one or more antenna stations 10, an optical distribution unit 20, a fronthaul multiplexer 30b, one or more aggregation stations 40, and a controller 50b. Although FIG. 7 shows the case where the communication system 100b includes three antenna stations 10-1 to 10-3 and two aggregation stations 40-1 to 40-2, the number of the antenna stations 10 and aggregation stations 40 is not particularly limited.

An optical transmission line connects the antenna stations 10-1, 10-2, and 10-3 to the optical distribution unit 20, the optical distribution unit 20 to the fronthaul multiplexer 30b, the fronthaul multiplexer 30b to the aggregation station 40-1, and the optical distribution unit 20 to the aggregation stations 40-2 and 40-3. An electric line for transmitting electric signals connects the controller 50b and the optical distribution unit 20, the controller 50b and the fronthaul multiplexer 30b, and the controller 50b and the aggregation stations 40-1 and 40-2.

In FIG. 7, it is assumed that the antenna station 10-1 is accommodated in the aggregation station 40-1 via the optical distribution unit 20 and the fronthaul multiplexer 30b, and the antenna stations 10-2 and 10-3 are accommodated in the aggregation stations 40-2 and 40-3 via the optical distribution unit 20. The fronthaul multiplexer 30b is accommodated in the aggregation station 40-1.

The communication system 100b is different in configuration from the communication system 100 in that it includes a fronthaul multiplexer 30b and a controller 50b in place of the fronthaul multiplexer 30 and the controller 50, and in that it includes three antenna stations 10 and aggregation stations 40. The other configurations of the communication system 100b are the same as those of the communication system 100. Hereinafter, the difference will be mainly described.

The controller 50b controls the entire communication system 100b. The controller 50b acquires determination information used for sleep control of the aggregation station 40 from each of the plurality of aggregation stations 40. Further, the controller 50b acquires the delay time (hereinafter referred to as “lower delay time”) from the antenna station 10 whose connection destination is switched to the fronthaul multiplexer 30b in advance in response to the switching of the connection relationship by the optical distribution unit 20. Here, the acquisition target of the lower delay time by the controller 50b is the antenna station 10 where a new connection destination is connected to the aggregation station 40 via the optical distribution unit 20 and the fronthaul multiplexer 30. This is because the lower delay time between the antenna station 10-1 and the fronthaul multiplexer 30b is measured since the communication is performed between the antenna station 10-1 and the aggregation station 40-1 in the antenna station 10 (for example, the antenna station 10-1) connected to the aggregation station 40 via the optical distribution unit 20 and the fronthaul multiplexer 30 before the optical distribution unit 20 performs the connection switching.

In the example shown in FIG. 7, the antenna stations 10-2 and 10-3 are connected to the aggregation station 40 connected to the path via the optical distribution unit 20 and not via the fronthaul multiplexer 30. For this, the lower delay time between each of the antenna stations 10-2 and 10-3 and the fronthaul multiplexer 30b is not measured. Thus, the antenna stations 10-2 and 10-3 are the targets of acquiring the lower delay time by the controller 50b. The controller 50b notifies the fronthaul multiplexer 30b of the acquired information on the lower delay time. Therefore, the fronthaul multiplexer 30b does not need to measure the delay time with the newly connected antenna station 10 again by recycling the value of the lower delay time notified from the controller 50b.

The fronthaul multiplexer 30b behaves in such a way that the plurality of connected antenna stations 10 appears to be one antenna station 10 when viewed from the aggregation station 40. The fronthaul multiplexer 30b receives the uplink signal transmitted from each of the antenna stations 10. The fronthaul multiplexer 30b merges each uplink signal by performing signal processing on the signal corresponding to the same time point on each received uplink signal. Therefore, the fronthaul multiplexer 30b generates the multiplex signal. The fronthaul multiplexer 30b outputs the generated multiplex signal to the aggregation station 40-1.

The fronthaul multiplexer 30b acquires information on the lower delay time from the controller 50b in advance when imparting the delay to each uplink signal. Then, the fronthaul multiplexer 30b acquires the delay time to be imparted to the uplink signal transmitted from each of the antenna stations 10 on the basis of the acquired information on the lower delay time. As mentioned above, the lower delay time is the delay time between the antenna station 10 and the fronthaul multiplexer 30b. The fronthaul multiplexer 30b acquires the delay time to be imparted to each uplink signal for each uplink signal so that the same delay is obtained by taking into account the lower delay time in order to add or select signals corresponding to the same time point when merging each uplink signal. Then, the fronthaul multiplexer 30b can merge each uplink signal by imparting the acquired delay time to each uplink signal.

Next, the functions included in the fronthaul multiplexer 30b and the controller 50b will be described in detail. First, the functions included in the fronthaul multiplexer 30b will be described. The fronthaul multiplexer 30b includes a lower-side delay insertion unit 31b, a signal merging unit 32, and a switching notification receiving unit 33.

The switching notification receiving unit 33 receives information on the lower delay time corresponding to the antenna station 10 (hereinafter referred to as “a switching target antenna station”) newly connected to the fronthaul multiplexer 30b from the controller 50b. The switching notification receiving unit 33 acquire the delay time to be imparted to the uplink signal transmitted from each of the antenna stations 10 connected to the fronthaul multiplexer 30b on the basis of the received information on the lower delay time and the insertion delay table. Hereinafter, the delay time to be imparted to the uplink signal will be referred to as the insertion delay time. The insertion delay table is a table in which information about insertion delay time is registered. The details of the insertion delay table will be described later. The insertion delay table is stored in a memory that is not shown by drawings. The switching notification receiving unit 33 notifies the lower-side delay insertion unit 31b of the acquired information on the insertion delay time of each antenna station 10.

The lower-side delay insertion unit 31b receives each uplink signal transferred from the optical distribution unit 20. The lower-side delay insertion unit 31b imparts the delay value indicated by information on the delay time notified from the switching notification receiving unit 33 to at least some of the received uplink signals. Therefore, the lower-side delay insertion unit 31b can make each uplink signal transmitted from the different antenna station 10 a signal received at the same time point.

Next, the functions included in the controller 50b will be described. The controller 50b includes an acquisition unit 51, a sleep control unit 52, a sleep detection unit 53, a switching signal transmission unit 54, and a delay time management unit 55.

When the sleep detection unit 53 detects the migration of the sleep target aggregation station to the sleep state, the delay time management unit 55 acquires information on the lower delay time corresponding to the switching target antenna station. The delay time management unit 55 may calculate the lower delay time from a measurement value using an AMCC (Auxiliary Management and Control Channel) or may hold a value once measured in the past in the fronthaul multiplexer 30b. Note that, in the case of using AMCC, the delay time management unit 55 sends a delay measurement signal to the switching target antenna station to measure the propagation delay between the optical distribution unit 20 and the switching target antenna station, and holds the value obtained by halving the round-trip delay time as the one-way delay, for example.

When the switching signal transmission unit 54 sends the switching signal to the optical distribution unit 20, the delay time management unit 55 notifies the switching notification receiving unit 33 of the fronthaul multiplexer 30 that the switching target antenna station is connected and the information on the delay time corresponding to the switching target antenna station to be connected from now.

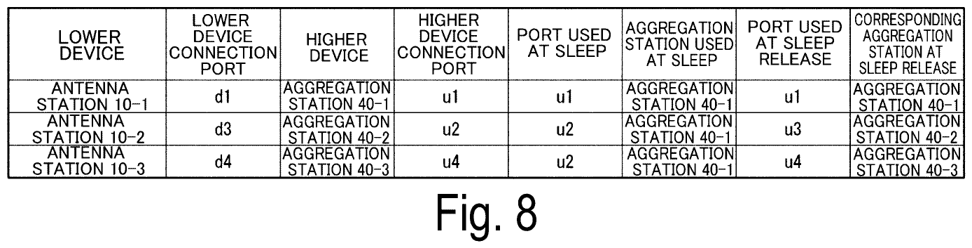

FIG. 8 is a diagram showing a configuration example of an optical distribution unit connection table according to the third embodiment. Note that since each value registered in the optical distribution unit connection table is the same as that described in FIG. 2, description thereof will be omitted.

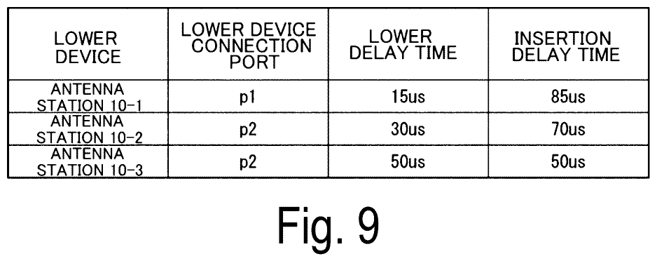

FIG. 9 is a diagram showing a configuration example of the insertion delay table according to the third embodiment. The insertion delay table has a plurality of records in which information about the insertion delay time is registered. Each record has values of the lower device, lower device connection port, lower delay time, and insertion delay time. The lower device in the insertion delay table represents lower device connected to the fronthaul multiplexer 30b. The lower device connected to the fronthaul multiplexer 30b is the antenna station 10, for example. The lower device connection port represents the first port of the fronthaul multiplexer 30b to which the lower device is connected.

The lower delay time represents a delay time required for transmission between the antenna station 10 and the fronthaul multiplexer 30b. The insertion delay time represents the delay time to be imparted to the uplink signal. As shown in FIG. 9, it is assumed that the lower delay time from each of the antenna stations 10-1, 10-2, and 10-3 to the fronthaul multiplexer 30b is 15 us, 30 us, and 50 us. The delay time management unit 55 acquires the insertion delay time based on the lower delay time so that the total value of the lower delay time and the insertion delay time becomes the same value (so that they become the same delay) in each of the antenna stations 10-1, 10-2, and 10-3. For example, FIG. 9 shows an example in which the insertion delay time is acquired so that the total value becomes 100 us.

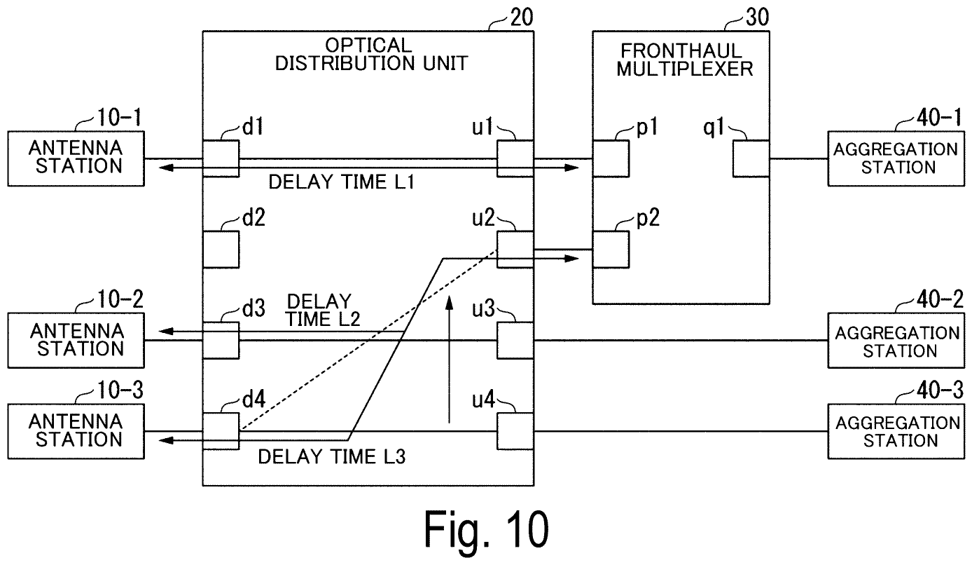

FIG. 10 is a diagram for explaining the switching of the connection relationship of the optical distribution unit 20 according to the third embodiment. In FIG. 10, as one example, a configuration will be described, in which the optical distribution unit 20 has four first ports d1 to d4 and four second ports u1 to u4 and the fronthaul multiplexer 30b has two first ports p1 to p2 and one second port q1. Note that the number of ports included in the optical distribution unit 20 and the fronthaul multiplexer 30b is not limited to the example shown in FIG. 10.

As shown in FIG. 10, the antenna station 10-1 is connected to the first port d1 of the optical distribution unit 20, the antenna station 10-2 is connected to the first port d3 of the optical distribution unit 20, and the antenna station 10-4 is connected to the first port d4 of the optical distribution unit 20. Further, the fronthaul multiplexer 30b is connected to the second ports u1 and u2 of the optical distribution unit 20, the aggregation station 40-2 is connected to the second port u3 of the optical distribution unit 20, and the aggregation station 40-3 is connected to the second port u4 of the optical distribution unit 20.

The optical distribution unit 20 is connected to the first ports p1 and p2 of the fronthaul multiplexer 30b, and the aggregation station 40-1 is connected to the second port q1 of the fronthaul multiplexer 30b. Inside the optical distribution unit 20, the first port d1 and the second port u1 are connected, the first port d3 and the second port u3 are connected, and the first port d4 and the second port u4 are connected.

Here, the flow of connection switching of the optical distribution unit 20 by using the connection relationship shown in FIG. 10 as an example will be described using the optical distribution unit connection table shown in FIG. 8 and the insertion delay table shown in FIG. 9. When the sleep detection unit 53 detects the migration of the aggregation station 40-3 to the sleep state, the delay time management unit 55 refers to the insertion delay table to judge whether or not information on the lower delay time between the antenna station 10-3 accommodated in the aggregation station 40-3 and the fronthaul multiplexer 30b is registered. When the information on the lower delay time between the antenna station 10-3 accommodated in the aggregation station 40-3 and the fronthaul multiplexer 30b is registered, the delay time management unit 55 acquires the insertion delay time by using the registered information on the lower delay time.

For example, in the example shown in FIG. 10, the antenna station 10 connected to the fronthaul multiplexer 30b is only the antenna station 10-1. Thus, the delay time management unit 55 acquires the insertion delay time so as to become the same delay on the basis of the lower delay time between the antenna station 10-1 and the fronthaul multiplexer 30b and the lower delay time between the antenna station 10-3 accommodated in the aggregation station 40-3 and the fronthaul multiplexer 30b.

The delay time management unit 55 notifies the fronthaul multiplexer 30b of the acquired information on the insertion delay time and information for specifying the antenna station 10 to be connected from now. For example, when acquiring the insertion delay time so as to be 100 us as shown in FIG. 9, the delay time management unit 55 acquires 85 us (=100 us−15 us) as the insertion delay time for the antenna station 10-1, and acquires 50 us (=100 us−50 us) as the insertion delay time for the antenna station 10-3. In this way, the delay time management unit 55 determines the total value of the lower delay time and the insertion delay time and acquires the insertion delay time by subtracting the lower delay time from the determined total value.

The switching notification receiving unit 33 of the fronthaul multiplexer 30b grasps the antenna station 10 to be connected from now on the basis of the information transmitted from the controller 50b. Further, the switching notification receiving unit 33 sets information on the insertion delay time corresponding to each of the antennas obtained from the controller 50b to the lower-side delay insertion unit 31 at the timing when the switching of the optical distribution unit 20 is performed. For example, the switching notification receiving unit 33 is set to impart the delay of 85 us to the uplink signal transmitted from the antenna station 10-1, and set to impart the delay of 50 us to the uplink signal transmitted from the antenna station 10-3.

When the sleep detection unit 53 detects the migration of the aggregation station 40-3 to the sleep state, the switching signal transmission unit 54 refers to the optical distribution unit connection table to grasp that the aggregation station 40-3 is connected to the second port u4 of the optical distribution unit 20. Further, the switching signal transmission unit 54 grasps that the antenna station 10-3 accommodated in the aggregation station 40-3 is connected to the first port d4 of the optical distribution unit 20.

Thereafter, the switching signal transmission unit 54 refers to the items of the port used at sleep and the aggregation station used at sleep in the optical distribution unit connection table to grasp that the connection destination of the antenna station 10-3 is the aggregation station 40-1 and utilization of the second port u2 of the optical distribution unit 20 toward the aggregation station 40-1 when the aggregation station 40-3 is asleep. Therefore, the switching signal transmission unit 54 generates the switching signal that instructs to switch the connection connected from the first port d4 of the optical distribution unit 20 to the second port u4 of the optical distribution unit 20 to a connection connected from the first port d4 of the optical distribution unit 20 to the second port u2 of the optical distribution unit 20. The switching signal transmission unit 54 transmits the generated switching signal to the optical distribution unit 20. Therefore, the optical distribution unit 20 switches the connection so as to connect the first port d4 and the second port u2 as shown by a dotted line in FIG. 10.

Following the switching of the connection relation of the optical distribution unit 20, the switching notification receiving unit 33 of the fronthaul multiplexer 30b sets the lower-side delay insertion unit 31 so as to impart the delay of 85 us to the uplink signal transmitted from the antenna station 10-1 and sets the lower-side delay insertion unit 31 so as to impart the delay of 50 us to the uplink signal transmitted from the antenna station 10-3. With such settings, the above-described delays are imparted to the uplink signals transmitted from the respective antenna stations 10-1 and 10-3 in the fronthaul multiplexer 30b. As a result, the time point is adjusted and the signal merging unit 32 generates the multiplex signal.

In the conventional technique, when a new antenna station is connected, the fronthaul multiplexer measures a propagation delay time between the fronthaul multiplexer and the newly connected antenna station and inserts a delay in the lower-side delay insertion unit so as to match the timing at which an uplink signal from another antenna station is transmitted to the aggregation station. On the other hand, according to the communication system 100b according to the third embodiment, the lower-side delay insertion unit 31 acquires the delay time (insertion delay time) to be imparted to the uplink signal of the newly connected antenna station 10 on the basis of information on the lower delay time received from the switching signal transmission unit 54 by the fronthaul multiplexer 30b. For this, in the fronthaul multiplexer 30b, when the antenna station 10 is newly connected by switching the optical distribution unit 20, the appropriate insertion delay time is determined without performing delay measurement, and the delay can be imparted by the lower-side delay insertion unit 31. For this, the switching can be completed in a shorter time. As a result, the occurrence of packet loss can be suppressed or the occurrence of packet loss can be prevented.

### Modification Example 1 of Third Embodiment

In the above-mentioned embodiment, the controller 50b determines whether or not to allow sleep and issues the switching instruction to the optical distribution unit 20. It may be configured to determine whether or not to allow the sleep and issue the switching instruction to the optical distribution unit 20 by different devices. When configured in this way, the communication system 100b according to the third embodiment includes a radio controller 60 and an optical distribution unit controller 65 in place of the controller 50b similarly to the modification example of the first embodiment. The radio controller 60 performs radio communication with the aggregation station 40 and with the optical distribution unit controller 65. The radio controller 60 includes an acquisition unit 51 and a sleep control unit 52.

The acquisition unit 51 included in the radio controller 60 acquires the determination information from each of the plurality of aggregation stations 40 by radio. The acquisition unit 51 acquires the determination information from each of the plurality of aggregation stations 40 at predetermined timing or periodically by radio, for example. The acquisition unit 51 outputs the acquired determination information of each aggregation station 40 to the sleep control unit 52. The sleep control unit 52 included in the radio controller 60 determines whether or not the aggregation station 40 can be asleep on the basis of the determination information of each aggregation station 40 acquired by the acquisition unit 51.

When determined to allow sleep, the sleep control unit 52 notifies the optical distribution unit controller 65 that the sleep target aggregation station is made asleep by radio. Further, when determined to allow sleep, the sleep control unit 52 transmits the sleep instruction to the sleep target aggregation station by radio.

The optical distribution unit controller 65 controls the optical distribution unit 20. The optical distribution unit controller 65 includes a sleep detection unit 53, a switching signal transmission unit 54, and a delay time management unit 55. The sleep detection unit 53 included in the optical distribution unit controller 65 detects the migration of the sleep target aggregation station to the sleep state in response to the notification from the radio controller 60. When the sleep detection unit 53 detects the migration of the sleep target aggregation station to the sleep state, the switching signal transmission unit 54 included in the optical distribution unit controller 65 transmits the switching signal to the optical distribution unit 20. The switching operation of the optical distribution unit 20 by the switching signal transmission unit 54 is the same as the method shown in the third embodiment.

When the sleep detection unit 53 detects the migration of the sleep target aggregation station to the sleep state, the delay time management unit 55 included in the optical distribution unit controller 65 acquires information on the lower delay time corresponding to the switching target antenna station. The processing performed by the delay time management unit 55 is the same as that in the third embodiment.

### Modification Example 2 of Third Embodiment

The communication system 100b may be configured to release the sleep of the sleeping aggregation station similarly to the second embodiment. Further, when configured to release the sleeping aggregation station, the communication system 100b may be configured to determine whether or not the sleep release is required and issue the switching instruction to the optical distribution unit 20 on different devices similarly to the modification example of the second embodiment.

### Modification Example Common to First to Third Embodiments

The aggregation station 40 may be a virtualized aggregation station 40. Therefore, the information processing device having the virtualization function can be used, and the above-described processing can be realized even if it is not on a dedicated device.

At least some or all of each functional unit of the fronthaul multiplexer 30 and 30b, and the controller 50 and 50b are realized as software by a processor such as a CPU (Central Processing Unit) executing a program stored in a storage device and a storage unit having a non-volatile recording medium (non-transitory recording medium). The program may be recorded on a computer-readable non-transitory recording medium. The computer-readable non-transitory recording medium is a non-temporary recording medium such as a portable medium such as a flexible disk, a magneto-optical disc, a ROM (Read Only Memory), or a CD-ROM (Compact Disc Read Only Memory), or a storage device such as a hard disk built into a computer system, for example.

At least some or all of each functional unit of the fronthaul multiplexer 30 and 30b or some or all of each functional unit of the controller 50 and 50b may be realized using hardware including electronic circuits (electronic circuit or circuitry) using, for example, an LSI (Large Scale Integrated circuit), an ASIC (Application Specific Integrated Circuit), a PLD (Programmable Logic Device), an FPGA (Field Programmable Gate Array), or the like.

Although the embodiment of the present invention has been described in detail with reference to the drawings above, a specific configuration is not limited to this embodiment, and design within the scope of the gist of the present invention, and the like are included.

### INDUSTRIAL APPLICABILITY

The present invention is applicable to a communication system including a fronthaul multiplexer.

### REFERENCE SIGNS LIST

10, 10-1 to 10-3 Antenna station
20 Optical distribution unit
30, 30b Fronthaul multiplexer
31, 31b Lower-side delay insertion unit
32 Signal merging unit
33 Switching notification receiving unit
40, 40-1 to 40-3 Aggregation station
50, 50b Controller
51 Acquisition unit
52 Sleep control unit
53 Sleep detection unit
54 Switching signal transmission unit
55 Delay time management unit
60 Radio controller
65 Optical distribution unit controller
100 Communication system

1. A control device comprising:
a sleep detector configured to detect a migration of a communication station, which is connected to a first path via an optical distributor that outputs signals outputted from one or more terminal accommodation stations to another path and not via a fronthaul multiplexer that multiplexes and outputs signals outputted from the one or more terminal accommodation stations, to a sleep state among a plurality of communication stations that accommodates the one or more terminal accommodation stations that communicate with a terminal; and
a switching signal transmitter configured to transmit a switching signal to the optical distributor that instructs to switch the terminal accommodation station accommodated in the communication station that has migrated to the sleep state to be accommodated in the communication station connected to a second path via the optical distributor and the fronthaul multiplexer when the sleep detector detects the migration of the communication station to the sleep state.

2. The control device according to claim 1, wherein
the sleep detector further detects that the communication station that has migrated to the sleep state has returned from the sleep state, and
the switching signal transmitter transmits the switching signal to the optical distributor so as to accommodate any terminal accommodation station accommodated in the communication station connected to the second path via the optical distributor and the fronthaul multiplexer in the communication station connected to the first path via the optical distributor and not via the fronthaul multiplexer when the sleep detector detects that the communication station that has migrated to the sleep state has returned from the sleep state.

313. The control device according to claim 1, further comprising:
a delay time manager configured to hold a lower delay time required for transfer between the one or more terminal accommodation stations and the optical distributor, wherein
the delay time manager notifies the fronthaul multiplexer of at least information on the terminal accommodation station to which connection is to be switched and information on a delay time based on the lower delay time in the terminal accommodation station to which the connection is to be switched when the sleep detector unit detects that the communication station has migrated to the sleep state.

4. The control device according to claim 3, wherein
the delay time manager acquires the delay time to be imparted to a signal to make it the signal received at the same time point in the fronthaul multiplexer on the basis of the lower delay time in the terminal accommodation station to which the connection is to be switched and the lower delay time in the terminal accommodation station accommodated in the communication station connected to the second path and notifies the fronthaul multiplexer of information on the terminal accommodation station to which the connection is to be switched and the acquired delay time.

515. The control device according to claim 1, further comprising:
an acquirer configured to acquire determination information used for determining whether or not the communication station can be asleep from each of the plurality of communication stations; and
a sleep controller configured to determine whether or not a communication station connected to the first path via the optical distributor and not via the fronthaul multiplexer can be asleep on the basis of the determination information acquired by the acquirer, wherein
the sleep detector detects the migration of the communication station to the sleep state on the basis of a determination result of the sleep controller.

6. A fronthaul multiplexer in a communication system including a plurality of terminal accommodation stations that communicates with a terminal, an optical distributor that outputs each signal outputted from the plurality of terminal accommodation stations to a distribution destination, and a fronthaul multiplexer that multiplexes and outputs each signal outputted from the optical distributor, the fronthaul multiplexer comprising:
a switching notification receiver configured to receive information on a delay time required for transfer between the terminal accommodation station to which connection is to be switched and the optical distributor and information on the terminal accommodation station to which the connection is to be switched;
a delay adjuster configured to adjust timing at which each signal received via the optical distributor is transmitted by imparting a delay to a signal outputted from the terminal accommodation station specified by the information on the terminal accommodation station to which the connection is to be switched on the basis of the information on the delay time received by the switching notification receiver; and
a signal merger unit configured to multiplex and output the signal outputted after being adjusted by the delay adjuster and the signal outputted from another terminal accommodation station.

7. A connection switching method comprising:
detecting a migration of a communication station, which is connected to a first path via an optical distributor that outputs signals outputted from one or more terminal accommodation stations to another path and not via a fronthaul multiplexer that multiplexes and outputs signals outputted from the one or more terminal accommodation stations, to a sleep state among a plurality of communication stations that accommodates the one or more terminal accommodation stations that communicate with a terminal; and
transmitting a switching signal to the optical distributor that instructs to switch the terminal accommodation station accommodated in the communication station that has migrated to the sleep state to be accommodated in the communication station connected to a second path via the optical distributor unit and the fronthaul multiplexer when detecting the migration of the communication station to the sleep state.

8. (canceled)
